(19) United States
(12) Patent Application Publication
(10) Pub. No.: US 2008/0264724 A1
(43) Pub. Date: Oct. 30, 2008

(54) ATTIC LADDER

(75) Inventor: Vanessa Cantu Gomez, Louisville, KY (US)

Correspondence Address: EGBERT LAW OFFICES, 412 MAIN STREET, 7TH FLOOR, HOUSTON, TX, 77002, US

(73) Assignee: Louisville Ladder Inc., Louisville, KY (US)

(21) Appl. No.: 11/740,764

(22) Filed: Apr. 26, 2007

(51) Int. Cl. E06C 9/00

(52) U.S. Cl. 182/95

(57) ABSTRACT

An attic ladder has a frame, a first side rail, a second side rail extending in parallel relationship with the first side rail and pivotally interconnected to the frame at an upper end thereof, and a plurality of steps extending between the side rails. Each of the steps are formed of a polymeric material. The side rails have a curved outer surface. A slidable base rail is mounted at a bottom of each of the side rails so as to support a shoe at a bottom thereof.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to attic ladders. More particularly, the present invention relates to attic ladders that have slip-resistant steps. Additionally, the present invention relates to attic ladders that can be adjustably supported against a floor surface.

2. Description of Related Art Including Information Disclosed Under 37 CFR 1.97 and 37 CFR 1.98

Most homes are constructed so as to have an attic positioned above the living space of the home. These attics are often used for the storage of various items. In certain circumstances, the attics are converted into living spaces. In many other circumstances, the attics are constructed so as to have only selective access.

Access to the attics is often carried out so as to retrieve articles that are stowed within the attic. In other circumstances, it is necessary to install various items, such as air conditioning equipment, insulation, piping, fans, and other items. In order to install these items, an access ladder is required so as to facilitate the ability of a person to enter the attic. In certain circumstances, conventional stepladders are utilized so as to allow a person to enter a trap door of the attic so as to gain access. In other circumstances, homeowners desire easier and more convenient access to the storage space in the attic. As such, attic ladders have been developed in the past whereby an opening of the trap door will expose a ladder that is built into the trap door. Typically, these ladders can be extended or unfolded so that they can allow the homeowner to climb the steps and enter the attic in a safe and convenient manner. After access to the attic is completed, the ladder can be folded upon itself and returned to its stowed space in the attic. In this manner, the ladder is stowed outside of the living space of the home.

Unfortunately, in the past, these attic ladders have been somewhat difficult to use. First, the steps of such a conventional attic ladder are of a relatively small size. In certain circumstances, they are formed of a rather slippery wooden material. Wooden dowel rods extend between the side rails of the ladder. These round rails sometimes fail to provide adequate support and, at least, fail to provide slip-resistant support to the person that is climbing the ladder. In other circumstances, these ladders do not extend fully to the floor of the home. As such, the user can climb a ladder that is only supported from an upper end thereof. This can cause a flexing or movement of the ladder as the user traverses the ladder in order to enter the attic.

In many circumstances, the user climbs the ladder by grasping a step, placing a foot on a lower step and climbing the manner in which a person a climb a conventional ladder. When the person reaches the upper end of the ladder, there are often difficult surfaces to grasp in order to complete the climbing. As such, a need has developed so as to facilitate the ability to climb the ladder in a safe and easy manner.

Most existing attic ladders are simple mechanical devices. In other words, when the trap door is opened, the ladder is unfolded and then climbed. The unfolding of the ladder can be relatively noisy. Since the ladder is unfolded through the assistance of gravity, the lower portions of the ladder can be unfolded in a haphazard manner. It can be difficult for elderly or frail individuals to effectively fold the ladder and return the ladder to its stowed position within the attic. As such, a need has developed in order to supplement the strength of the user in order to effectively return the ladder to its stowed position.

Certain attic ladders have generally flat sides. These flat sides can result in relatively sharp edges on the side rails of the ladder. Additionally, such flat sides may present a less than the desirable aesthetic appearance of the attic ladder.

The hinges associated with such attic ladders are often a point of weakness in the construction of such attic ladders. Since these hinges often require the necessary strength and attachment to the ladder in order to support the weight of the individual climbing the ladder, the integrity of the hinges can tend to decline over time. Often, these hinges are simply installed into wooden attic ladders with simple wood screws. These wood screws can eventually dethread or otherwise become loosened. As a result, the portions of the side rails of the ladder will tend to be somewhat wobbly. As such, a need has developed so as to ensure that there is a strong and permanent hinged connection between the various portions of the ladder.

It is an object of the present invention to provide an attic ladder that has slip-resistant steps.

It is another object of the present invention to provide an attic ladder which utilizes polymeric steps.

It is a further object of the present invention to provide an attic ladder that has an aesthetically pleasing appearance.

It is a further object of the present invention to provide an attic ladder that assures a strong connection between the bottom of the ladder and the floor of the living space in which the attic ladder is installed.

It is another object of the present invention to provide an attic ladder that includes a hinged connection between the side rail portions which will not deteriorate over time and which will provide a strong and fixed connection between the portions.

It is a further object of the present invention to provide an attic ladder which facilitates the ability of the user to climb the ladder and to provide proper support when the user reaches the upper limits of the ladder.

It is still another object of the present invention to provide an attic ladder which provides pneumatic assistance so as to overcome the effects of gravity when returning the ladder to its stowed position.

It is still another object of the present invention to provide an attic ladder which can be moved between the extended position and the stowed position with minimal noise.

These and other objects and advantages of the present invention will become apparent from a reading of the attached specification and appended claims.

### BRIEF SUMMARY OF THE INVENTION

The present invention is an attic ladder that comprises a frame, a first side rail, a second side rail extending in generally parallel relationship to the first side rail, and a plurality of steps extending between the first and second side rails. The first and second rails are pivotally connected or interconnected to the frame at an upper end thereof. Each of the plurality of steps is formed of a polymeric material. Each of the plurality of steps has a generally flat upper surface.

In the present invention, each of the plurality of steps has embossings on the generally flat upper surface. Each of the side rails has a generally curved outer surface. Each of the plurality of steps has a first projection extending outwardly on one side thereof and a second projection extending outwardly on an opposite side thereof. The first projection is received in and affixed to an interior of the first side rail. The second projection is received in and affixed to an interior of the second side rail.

In the present invention, a panel is hingedly connected to the frame. This panel extends in spaced parallel relationship to the first and second side rails. Each of the first and second side rails has a width dimension. Each of the plurality of steps also has a width dimension that is greater than the width dimension of the first and second side rails. Each of the plurality of steps extends into the space between the side rail and the panel.

Each of the first and second side rails has a channel defined on an interior thereof. A base rail is slidably received in the channel at a bottom of the side rail. A shoe is affixed to the bottom of the base rail opposite the side rail. The base rail has an interior channel defined by a surface and a pair of sides extending transversely from opposite edges of the surface. The shoe has an upper portion affixed to the surface. The base rail has a bottom abutting a top of a flange of the shoe. The shoe has a corrugated surface at a bottom of the flange of the shoe. The shoe is formed of a polyvinyl chloride polymeric material. The side rail and the base rail are formed of a metallic material.

Each of the first and second side rails includes a first rail portion, a second rail portion, and a hinge affixed to the first and second rail portions. Each of the rail portions has an interior channel. The hinge is affixed within the interior channel of the rail portions so as to cause the rail portions to move between a first position in which the rail portions are longitudinally aligned with each other and a second position in which the first rail portion overlies the second rail portion. The hinge has a pivot point adjacent a side of the first and second side rails. The hinge has a first abutment surface overlying the end of the first rail portion and second abutment surface overlying the end of the second rail portion. The first and second abutment surfaces are in surface-to-surface contact when the rail portions are in the first position.

A handrail extends in parallel relationship to one of the first and second side rails. A first member extends transversely to the first side rail and a second member extends transversely to the first side rail in spaced relationship to the first member. The handrail is affixed to an end of the first and second members opposite the first side rail. The first and second members are formed of a metallic material. The handrail is formed of a wooden material.

A first bar is pivotally connected at one end to one side of the frame and affixed to the first side rail at an opposite end. A second bar is pivotally connected at one end to an opposite side of the frame and affixed to the second side rail at an opposite end. A third bar is affixed to one of the first and second side rails in spaced relationship to the second bar. A pneumatic cylinder has an end affixed to the frame and an opposite end connected to the third bar opposite the side rail.

### BRIEF DESCRIPTION OF THE SEVERAL VIEWS OF THE DRAWINGS

FIG. 1 is a perspective view of the attic ladder in accordance with the preferred embodiment of the present invention.

FIG. 2 is a top perspective view of an individual step as used in the attic ladder of the present invention.

FIG. 3 is a perspective view showing the bottom rail and shoe connected to each of the side rails of the present invention.

FIG. 4 is a perspective exploded view showing the attachment of the shoe to the bottom of the bottom rail of the attic ladder of the present invention.

FIG. 5 is a perspective view of the hinges that are used to secure the rail portions to each other in the attic ladder of the present invention.

FIG. 6 is a side elevational view showing the relationship of each of the steps and the side rails to the panel associated with the trap door of the attic frame.

FIG. 7 illustrates the bars that are used with the pneumatic cylinder for the movement of the upper end of the ladder relative to the attic frame.

FIG. 8 is a cross-sectional view showing the manner in which the projection of a step is secured within the interior channel of the side rail.

### DETAILED DESCRIPTION OF THE INVENTION

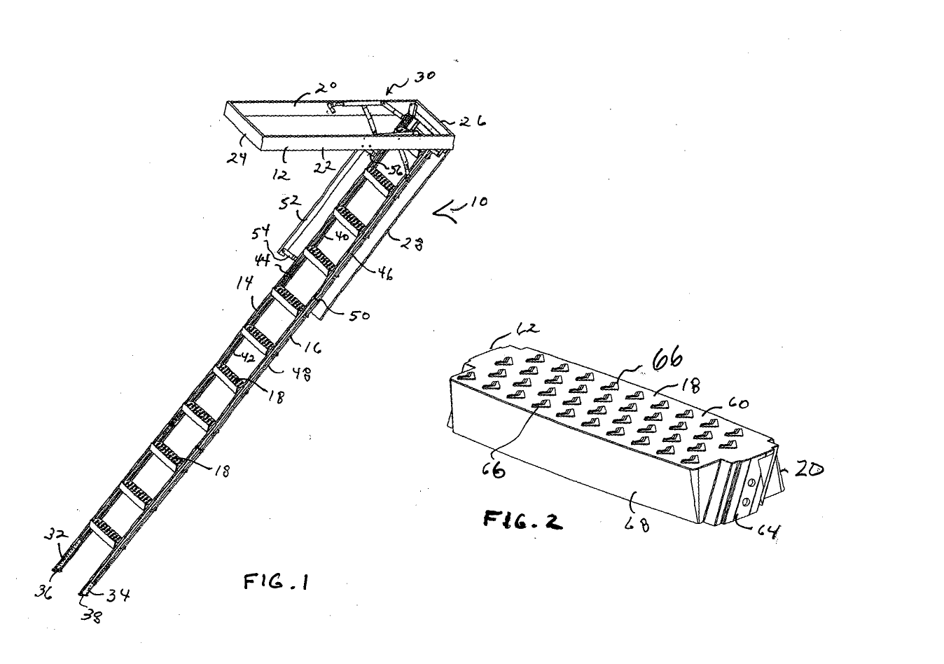

Referring to FIG. 1, there is shown the attic ladder 10 in accordance with the preferred embodiment of the present invention. The attic ladder 10 includes a frame 12, a first side rail 14, a second side rail 16 and a plurality of steps 18. The second side rail 16 extends in generally parallel relationship to the first side rail 14. The first side rail 14 and the second side rail 16 are pivotally or interconnected to the frame 12 at an upper end thereof. The plurality of steps 18 extend between the first side rail 14 and the second side rail 16. Each of the plurality of steps 18 is formed of a polymeric material. Each of the plurality of steps 18 has a generally flat upper surface.

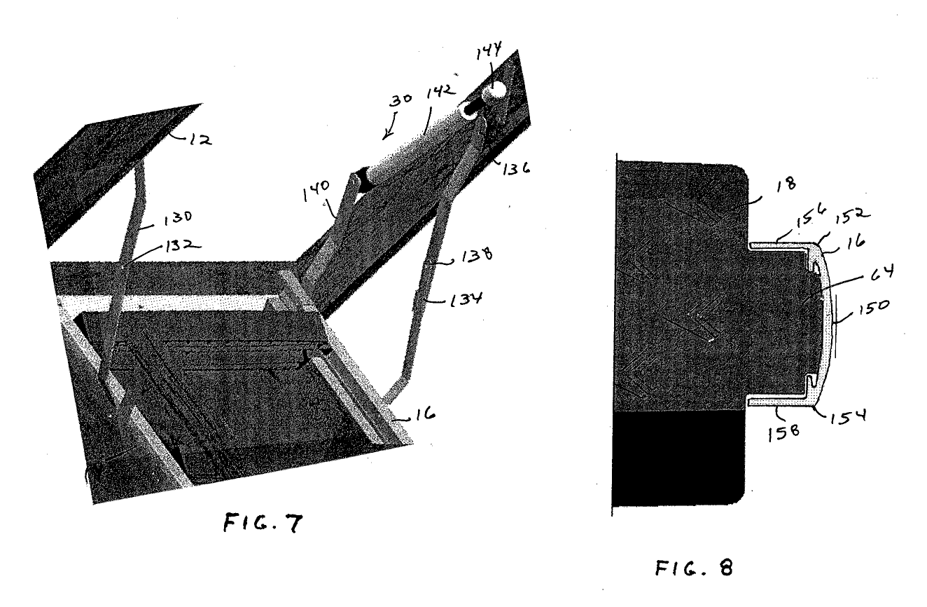

As can be seen in FIG. 1, the frame 12 is generally mounted in an opening in the attic. This is in accordance with conventional attic ladders. The frame 12 is particularly mounted in an opening in the attic so as to secure the attic ladder in a proper position. The frame 12 has a generally rectangular configuration. In particular, the frame 12 has sides 20 and 22 extending in parallel relationship to each other. Ends 24 and 26 extend between each of the sides 20 and 22 at respective opposite ends thereof. The upper end of the side rails 14 and 16 are pivotally interconnected to the frame 20 adjacent to the end 26. A panel 28 is pivotally connected to the end 26 of frame 12. The panel 28 can be in the nature of a trap door that is used with conventional attic ladders. When the side rails 14 and 16 of the attic ladder 10 are in a stowed position, the panel 28 will extend over the bottom of the frame 12 so as to enclose the side rails 14 and 16, along with the plurality of steps 18, within the interior of the attic. A lifting assist mechanism 30 is secured to the sides 20 and 22 of the frame 12 so as to facilitate the ability to lift and lower the side rails 14 and 16 of the attic ladder 10. A description of the lifting mechanism 30 is provided in association with the description of FIG. 7.

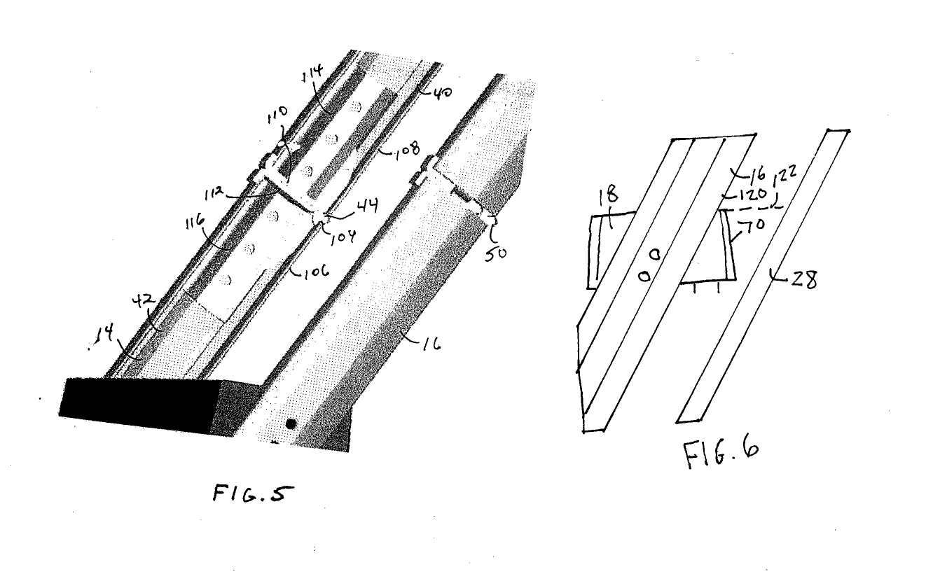

A first base rail 32 is slidably received at a bottom end of the first side rail 14. Another base rail 34 is slidably received by the bottom of the second side rail 16. The base rails 32 and 34 have shoes 36 and 38, respectively, affixed to a bottom end thereof opposite the bottom of the side rails 14 and 16. The side rail 14 includes a first rail portion 40 that is hingedly connected to a second rail portion 42. A hinge 44 connects the rail portions 40 and 42. This hinge is described in greater detail in association with FIG. 5. Similarly, the side rail 16 includes a first rail portion 46 and a second rail portion 48 that are hingedly connected together by a hinge 50. Hinges 44 and 50 allow the respective rail portions to be folded so as to overlie one another in one position or extend in a longitudinally aligned configuration in another position.

A handrail 52 is connected by members 54 and 56 to the first side rail 14. Members 54 and 56 extend transversely out from the side rail 14. The handrail 52 is connected to an opposite end of the members 54 and 56 from the side rail 14. The handrail 52 extends in spaced parallel relationship to the side rail 14. In the preferred embodiment of the present invention, the handrail 52 will be formed of a wooden material. The members 54 and 56 are formed of a metallic material. The handrail 52 facilitates the ability of a person climbing the attic ladder 10 of the present invention to enter the attic and to effectively and safely reach the upper level of the attic ladder 10.

FIG. 1 shows the attic ladder 10 in its extended configuration in a position suitable for climbing. In this configuration, the first rail portion 40 is in longitudinal alignment with the second rail portion 42 of first side rail 14 and the first rail portion 46 is in longitudinal alignment with the second rail portion 48 of second side rail 16. In other words, the hinges 44 and 50 have been pivoted so that the side rails 14 and 16 extend in longitudinally parallel relationship to each other and the rail portions are in longitudinal alignment. The base rails 32 and 34 slide outwardly such that the shoes 36 and 38 will contact an underlying surface, such as a floor. Each of the plurality of steps 18 has a flat upper surface. As such, the user can start climbing the steps 18 in a conventional manner. The base rails 32 and 34 provided added support for the attic ladder 10 so that the climbing can be carried out in a secure manner. As the user reaches the upper steps 18, the user can grasp the handrail 52 and climb further so as to enter the attic through the opening of the frame 12.

After use, the ladder portions can be folded so as to overlie one another by rotating the hinges 44 and 50. The base rails 32 and 34 can telescope inwardly. The panel 28 can be pushed upwardly with the assistance of the lifting mechanism 30 such that the side rails 14 and 16, along with their steps 18, are properly stowed within the interior of the frame 12.

FIG. 2 shows an isolated view of a step 18. It can be seen that the step 18 has a flat upper surface 60. A first projection 62 extends outwardly from one end of the step 18. A second projection 64 extends outwardly on an opposite end for the step 18. The projections 62 and 64 are respectively received within the interior channels defined by these side rails 14 and 16, respectively. It can be seen that the projections 62 and 64 have surfaces that are canted at an angle so as to assure that the flat upper surface 60 resides in a horizontal orientation when the attic ladder 10 is in its lowered and extended position. The step 18 is formed of a polymeric material. Embossings 66 are formed on the flat upper surface 60. Embossings 66 enhance the slip-resistance of the step 18. Since the step 18 has a flat upper surface 60 and the embossings 66, it presents a very secure step for the user. This avoids the round dowel-shaped steps of the prior art. Additionally, the polymeric material used for the step 18 further enhances the slip resistance of the step. The sides 68 and 70 of the step 18 extend downwardly at an angle. Sides 68 and 70 enhance the structural integrity of the polymeric step 18. The box-like structure of each of the steps 18 is engineered so as to make the step 18 stronger than conventional wooden steps.

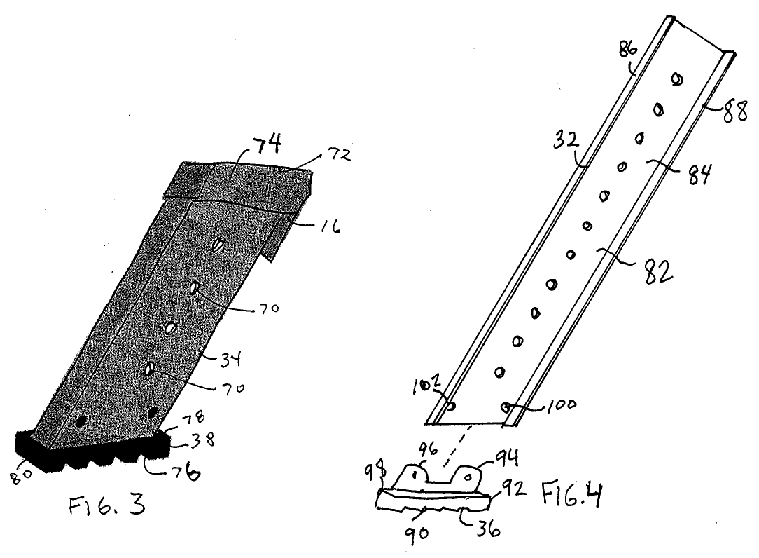

FIG. 3 is an isolated view of the base rail 34 as received within the interior channel of the side rail 16. The base rail 34 has a generally square C-shaped cross section. Various holes 70 are formed through the base rail 34. Holes 70 facilitate the ability of the base rail 34 to be in a fixed position relative to the side rail 16. These holes 70 can coincide with holes 72 formed through the outer surface 74 of the side rail 16. Suitable fasteners can be extended through the holes 72 and 70 so as to assure a fixed connection between the base rail 34 and the side rail 16.

The shoe 38 is secured to the bottom of the base rail 34. Shoe 38 is formed of a polyvinyl chloride (PVC) material. The shoe 38 has a corrugated bottom surface 76 which will provide strong gripping forces against an underlying surface, such as a floor. The bottom of the base rail 34 will abut the top surface 78 of the flange 80 of shoe 38. This abutting relationship between the bottom of base rail 34 and the top surface 78 of flange 80 further enhances the connection therebetween and avoids slippage and deterioration over time. Additionally, furthermore, the shoe 38 prevents any damaging contact between the sharp bottom edges of the base rail 34 and an underlying surface. As a result, the configuration of the present invention will avoid any scratching or marring of the underlying surface.

FIG. 4 shows the manner in which the shoe 36 is received within the interior channel 82 of the base rail 32. It can be seen that the base rail 32 also has a plurality of holes extending in longitudinal alignment through the surface 84 of the base rail 32. The base rail 32 has a configuration identical to the base rail 34. Sides 86 and 88 extend transversely outwardly from opposite edges of the surface 84. The square C-shaped construction enhances the structural integrity of the base rail 32.

The shoe 36 is illustrated as having a corrugated bottom surface 90 formed at the bottom of the flange 92. A pair of ears 94 and 96 extend upwardly from the top surface 98 of the flange 92 of shoe 36. Each of the ears 94 and 96 has a hole formed therein. The holes of each of the ears 94 and 96 are arranged so as to coincide with the holes 100 and 102, respectively, formed at the bottom edge of the base rail 32. As such, the shoe 36 can be securely affixed within the internal channel of the base rail 32.

FIG. 5 illustrates the specific configuration of the hinge 44 that is mounted within the interior channel of the rail portions 40 and 42. The hinge 44 has a pivot point 104 formed adjacent to the side 106 of the rail portion 42 and adjacent to the side of rail portion 40. Hinge 44 has an abutment surface 110 overlying a bottom edge of the rail portion 40. Another abutment surface 112 overlies a top edge of the rail portion 42. When the rail portions 40 and 42 are in their longitudinally aligned position, the abutment surfaces 110 and 112 will be in surface-to-surface contact. Each of the abutment surfaces 110 and 112 has a thickness that matches or is greater than the thickness of each of the rail portions 40 and 42. As a result, any forces are distributed over a wider surface area so as to prevent any dislodgement of the rail portions 40 and 42 with respect to each other. Importantly, an extension member 114 is received within the interior channel of the rail portion 40 and extends from the abutment surface 110. Similarly, an extension member 116 extends in the interior channel of the rail portion 42 from the abutment surface 112. Once again, these extension members 114 and 116 serve to distribute the forces over a wider surface area and to assure proper alignment of the rail portions 40 and 42. Each of the extension members 114 and 116 can have a generally V-shaped cross section so as to enhance the structural integrity thereof. The hinge 50 of the second side rail 16 is identical to the hinge 44 of the first side rail 14.

FIG. 6 illustrates the manner in which the steps 18 of the present invention provide an enhanced step surface area from the panel 28. Since the side rail 16 extends in generally spaced parallel relationship to the panel 28, a proper space exists therebetween. The step 18 is secured to the side rail 16 such that the side 70 will reside beyond the edge 120 of the side rail 16. The broken line illustrated in FIG. 6 shows the amount of extra area whereby the user can place his or her toe without interfering contact with the panel 28. As such, the step 18 assures a greater surface area of contact between the foot of the user and the step 18. Unlike the prior art, the attic ladder 10 of the present invention provides the extra space illustrated by broken line 122 so as to more safely allow an individual to climb the steps 18.

FIG. 7 illustrates the lifting mechanism 30 of the present invention. In particular, the lifting mechanism 30 includes a first bar 130 that is pivotally connected at one end to the frame 12 and affixed at the opposite end to the side rail 14. A pivot point 132 is formed along the length of the bar 130 so as to facilitate the ability of the bar 130 to fold upon itself.

A second bar 134 has one end 136 pivotally connected to the frame 12 and an opposite end affixed to the side rail 16. Bar 132 also has a pivot point 138 formed therealong so as to allow the bar 134 to fold upon itself when the attic ladder is moved to its stowed position. A third bar 140 has one end affixed to the side rail 16 and an opposite end connected to a pneumatic cylinder 142. Pneumatic cylinder 142 has an opposite end 144 affixed to the frame 12. As the side rails 14 and 16 are moved upwardly to a stowed position, the pneumatic cylinder 142 will exert suitable lifting forces, in a quiet and efficient manner, so as to overcome the effects of gravity and to allow the user to easily lift the ladder into its stowed position. The pneumatic cylinder 142 also allows the user to quietly lower the side rails 14 and 16 while providing a slight resistance so as to prevent the attic ladder 10 from dropping rapidly due to the force of gravity. Once again, the present invention enhances the safety of the raising and lowering of the attic ladder 10.

The present invention offers an attractive curved side rail. As can be seen in FIG. 8, the side rail 16 has a curved outer surface 150. The edges 152 and 154 are suitably contoured so as to avoid any sharp edges. The projection 64 of the step 18 is fixedly received within the interior channel of the side rail 16. Suitable fasteners such as screws, bolts, or other items can be installed through the holes associated with the side rail 16 and the corresponding holes formed on outer surface of the projection 64. Additionally, the sides 156 and 158 of the side rail 16 can be crimped over the sides of the projection 64 so as to enhance the securing forces. The curved outer surface 150 presents an aesthetically pleasing appearance to the attic ladder of the present invention.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. An attic ladder comprising:
a frame;
a first side rail;
a second side rail extending in generally parallel relationship with said first side rail, said first and second rails being pivotally connected or interconnected to said frame at an upper end thereof, and
a plurality of steps extending between said first and second side rails, each of said plurality of steps being formed of a polymeric material, each of said plurality of steps having a generally flat upper surface.

2. The attic ladder of claim 1, each of said plurality of steps having embossing on said generally flat upper surface.

3. The attic ladder of claim 1, each of said first and second side rails having a curved outer surface.

4. The attic ladder of claim 3, each of said plurality of steps having a first projection extending outwardly on one side thereof and a second projection extending outwardly on an opposite side thereof, said first projection received in and affixed to an interior of said first side rail, said second projection received in and affixed to an interior of said second side rail.

5. The attic ladder of claim 1, further comprising:
a panel hingedly connected to said frame, said panel extending in spaced parallel relationship to said first and second side rails.

6. The attic ladder of claim 5, each of said first and second side rails having a width dimension, each of said plurality of steps having a width dimension that is greater than said width dimension of said first and second side rails, each of said plurality of steps extending into the space between the side rail and said panel.

7. The attic ladder of claim 1, each of said first and second side rails having a channel defined on an interior thereof, the attic ladder further comprising:
a base rail slidably received in said channel at a bottom of said side rail; and
a shoe affixed to a bottom of said base rail opposite the side rail.

8. The attic latter of claim 7, said base rail having an interior channel defined by a surface and a pair of sides extending transversely from opposite edges of said surface, said shoe having an upper portion affixed against said surface, the base rail having a bottom abutting a top of a flange of said shoe, said shoe having a corrugated surface at a bottom of said flange of said shoe.

9. The attic latter of claim 7, said shoe being formed of a polyvinyl chloride polymeric material, the side rail and said base rail being of a metallic material.

10. The attic latter of claim 1, each of said first and second side rails comprising:
a first rail portion having an end, said first rail portion having an interior channel;
a second rail portion having an end, said second portion having an interior channel; and
a hinge affixed within said interior channel of said first and second rail portions so as to cause said first and second rail portions to move between a first position in which said first and second rail portions are aligned and a second position in which said first rail portion overlies said second rail portion.

11. The attic latter of claim 10, said hinge having a pivot point adjacent a side of said first and second side rails, said hinge having a first abutment surface overlying said end of said first rail portion and second abutment surface overlying said end of said second rail portion, said first and second abutment surfaces being in surface-to-surface contact when in said first position.

12. The attic latter of claim 1, further comprising:
a handrail extending in parallel relationship to one of said first and second side rails.

13. The attic latter of claim 12, further comprising:
a first member extending transversely to said first side rail; and
a second member extending transversely to said first side rail in spaced relationship to said first member, said handrail attached to an end of said first and second members opposite said first side rail, said first and second members being formed of a metallic material, said handrail being of a wooden material.

14. The attic latter of claim 1, further comprising:
a first bar pivotally connected at one end to one side of said frame and affixed to said first side rail at an opposite end; and
a second bar pivotally connected at one end to an opposite side of said frame and affixed to said second side rail at an opposite end thereof.

15. The attic latter of claim 14, further comprising:
a third bar affixed to one of said first and second side rails in spaced relationship to said second bar; and
a pneumatic cylinder having an end affixed to said frame and an opposite end affixed to said third bar opposite the side rail.

16. An attic ladder comprising:
a frame;
a first side rail;
a second side rail extending in generally parallel relationship with said first side rail, said first and second side rails being pivotally connected or interconnected to said frame at an upper end thereof, and
a plurality of steps extending between said first and second side rails, each of said first and second side rails having a curved outer surface.

17. The attic latter of claim 16, each of said plurality of steps having a first projection extending outwardly one side thereof and a second projection extending outwardly on an opposite sides thereof, said first projection received in and affixed to an interior of said first side rail, said second projection received in and affixed to an interior of said second side rail.

18. The attic latter of claim 16, further comprising:
a panel hingedly connected to said frame, said panel extending in spaced parallel relationship to said first and second side rails, each of said first and second side rails having a width dimension, each of said plurality of steps having a width dimension that is greater than said width dimension of said first and second side rails, each of said plurality of steps extending into the space between the side rail and said panel.

19. An attic ladder comprising:
a frame;
a first side rail;
a second side rail extending in generally parallel relationship to said first side rail, said first and second rails being pivotally connected or interconnected to said frame at an upper end thereof,
a plurality of steps extending between said first and second side rails, each of said first and second side rails having a channel defined on an interior thereof,
a base rail slidably received in said channel at a bottom of the side rail; and
a shoe affixed to a bottom of said base rail opposite the side rail.

20. The attic latter of claim 19, said base rail having an interior channel defined by a surface and a pair of sides extending transversely from opposite edges of said surface, said shoe having an upper portion affixed against said surface, the base rail having a bottom abutting a top of a flange of said shoe, said shoe having a corrugated surface at a bottom of said flange of said shoe.
